(19) United States
(12) Patent Application Publication
(10) Pub. No.: US 2010/0134497 A1
(43) Pub. Date: Jun. 3, 2010

(54) Methods, Systems, and Products for Graphing Data

(76) Inventors: Yifan Hu, Mountain Lakes, NJ (US); Yehuda Koren, Zichron Yaakov (IL)

Correspondence Address: AT&T Legal Department - SZ;Attn: Patent Docketing, Room 2A-207, One AT&T Way, Bedminster, NJ, 07921, US

(21) Appl. No.: 12/326,185

(22) Filed: Dec. 2, 2008

(51) Int. Cl. G06T 11/20

(52) U.S. Cl. 345/440

(57) ABSTRACT

Methods, systems, and products are disclosed for graphing data. A layout is retrieved that comprises locations for vertices. A proximity location is generated for each vertex. Each vertex's location from the layout is merged with each vertex's proximity location. A cost function associated with the layout is minimized.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Exemplary embodiments generally relate to electrical computers and, more particularly, to graphing data.

Graphing is important in mathematics and in computer science. Graphs are often used to visually depict relationships between data. A graph joins or connects a set of objects (e.g. “vertices” or “nodes”) with lines or edges. There may be many types of graphs, and graph theory has evolved as a disciplinary study of graphs and mathematical structures that model pairwise relations between objects.

The spring-electrical model, for example, is widely used for drawing graphs. The spring-electrical model is easy to implement and, when combined with the known multilevel approach and suitable data structures (e.g., quad-tree) to approximate long range repulsive forces, is efficient and generally effective for large graphs. The spring-electrical model, however, suffers from “warping” effects. When the spring-electrical model graphs vertices that are far away from a center of a layout, those vertices tend to be closer to each other. The spring-electrical model may also graph branches in a tree-like graph that tend to cling together. FIG. 1, for example, is a schematic that illustrates the warping problem. FIG. 1 illustrates a graphical output that applies a multilevel spring-electrical algorithm with a standard force model. One of ordinary skill in the art recognizes that the global structure of the graph is perhaps adequately captured. Locally, though, some vertices are too close to each other. For example, the vertices at the tip of a branch are much closer to each other than the vertices nearer a middle area. The tips of the branches may cling to each other, due to the strong long range repulsive force from far away vertices. These warping effects are particularly pronounced for large graphs, and warping effects may degrade the clarity of a drawing (particularly local details).

The stress model is another popular method of drawing a graph. The stress model may be based on realizing given distances between vertices. A cost function may be determined that is a difference between the physical distance of vertices and their ideal distance. The cost function is minimized, with the ideal distance determined from the graph theoretical distance among vertices. The stress model achieves more uniform edge lengths, thus at least minimizing warping effects. However, the calculation of graph theoretical distances among all vertex pairs makes the computational complexity quadratic in the number of vertices. The robustness and efficiency of this approach may be enhanced by a known stress majorization technique or by combining it with a known multilevel approach. Still, though, the quadratic complexity of the stress model may not be suitable for graphs with more than a few thousand vertices.

### SUMMARY

Exemplary embodiments provide methods, systems, and products for graphing data. Exemplary embodiments describe a computationally efficient algorithm that overcomes the warping effects of the spring-electrical model, without destroying the efficiency and good global structure that may be achieved with the spring-electrical model. Exemplary embodiments may utilize the fine control of edge length offered by the stress model, while avoiding its quadratic complexity. Exemplary embodiments achieve computational efficiency by allowing a vertex to move within a relative position. Each vertex, in other words, may be confined to a proximity location. This proximity location may be compared to an output of the spring-electrical model. A cost function may then be minimized. This technique may constrain the relative positions of the vertices and may preserve the global structure of the spring-electrical layout.

Exemplary embodiments include a method for graphing data. A layout is retrieved that comprises locations for vertices. A proximity location is generated for each vertex. Each vertex's location from the layout is merged with each vertex's proximity location. A cost function associated with the layout is minimized.

More exemplary embodiments include a system for graphing data. Means are disclosed for retrieving a layout that comprises locations for vertices. Means is included for generating a proximity location for each vertex. Means for merging each vertex's location from the layout with each vertex's proximity location is included. Means for minimizing a cost function associated with the layout is included.

Still more exemplary embodiments include a computer readable medium that stores instructions for performing a method of graphing data. A layout is retrieved that comprises locations for vertices. A proximity location is generated for each vertex. Each vertex's location from the layout is merged with each vertex's proximity location. A cost function associated with the layout is minimized.

Other systems, methods, and/or computer program products according to the exemplary embodiments will be or become apparent to one with ordinary skill in the art upon review of the following drawings and detailed description. It is intended that all such additional systems, methods, and/or computer program products be included within this description, be within the scope of the claims, and be protected by the accompanying claims.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIG. 1 illustrates a conventional, prior art graphical output illustrating warping effects produced by a multilevel spring-electrical algorithm with a standard force model;

FIG. 2 is a simplified schematic illustrating an environment in which exemplary embodiments may be implemented;

FIG. 3 is a schematic illustrating a result of a localized stress model, according to exemplary embodiments;

FIG. 4 is a schematic illustrating a result of a proximity graph-based model, according to exemplary embodiments;

FIG. 5 is a schematic illustrating a proximity graph that applies a Delaunay triangulation to the vertices of FIG. 1, according to exemplary embodiments;

FIG. 6 is a schematic illustrating a relative neighborhood graph of the vertices of FIG. 1, according to exemplary embodiments;

FIG. 7 is a schematic illustrating another relative neighborhood graph of the vertices of FIG. 1, according to exemplary embodiments;

FIG. 8 is a schematic illustrating another result of a proximity graph-based model, according to exemplary embodiments;

FIG. 9 is another schematic illustrating graphs, according to exemplary embodiments;

FIG. 10 is a schematic illustrating another post-processing transformation, according to exemplary embodiments;

FIGS. 11 and 12 are schematics illustrating more graphs, according to exemplary embodiments;

FIG. 13 is a schematic illustrating a generic block diagram incorporating a post-processing application, according to exemplary embodiments;

FIG. 14 depicts other possible operating environments for additional aspects of the exemplary embodiments; and

FIGS. 14 and 15 are flowcharts illustrating a method of graphing data, according to exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

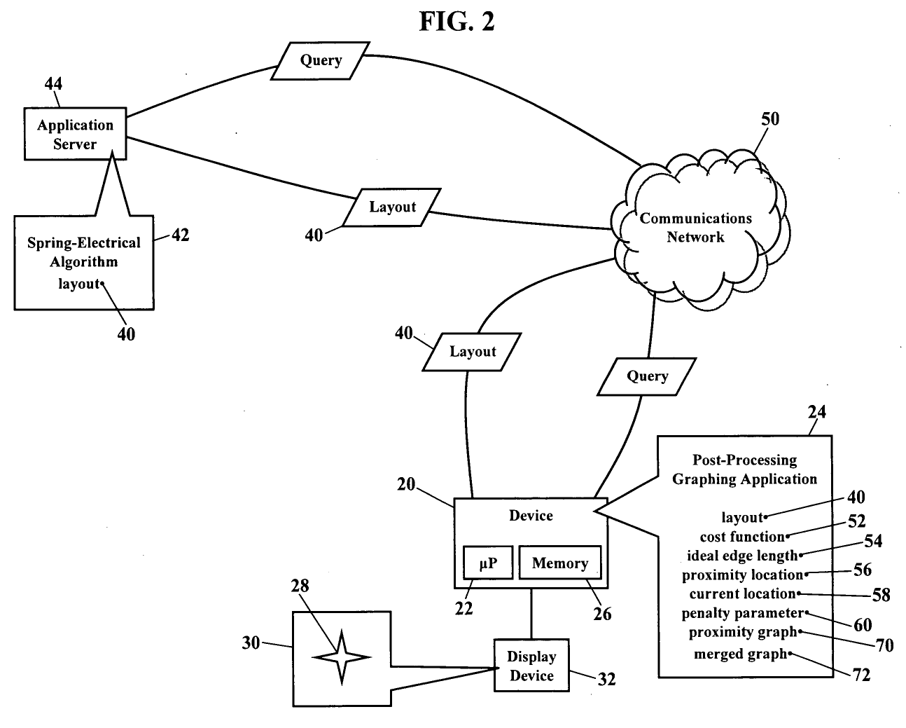

FIG. 2 is a simplified schematic illustrating an environment in which exemplary embodiments may be implemented. A device 20 has a processor 22 (e.g., “μP”), application specific integrated circuit (ASIC), or other component that executes a post-processing graphing application 24 stored in a memory 26. The post-processing graphing application 24 may cause the processor 22 to produce a graph 28. The graph 28 may be incorporated into or produced within a graphical user interface 30. The graph 28 and/or the graphical user interface 30 is/are illustrated as being visually produced on a display device 32, yet the graph 28 and/or the graphical user interface 30 may also have audible features. Although the device 20 is generically shown, the device 20, as later paragraphs will explain, may be any processor-controlled device.

The post-processing graphing application 24 accepts a layout 40 as an input. The layout 40 may be produced from a spring-electrical algorithm 42. FIG. 2 illustrates the layout 40 being retrieved from an application server 44. The application server 44 may execute the spring-electrical algorithm 42 and generate the layout 40. The device 20 then queries the application server 44 to retrieve the layout 40. The layout 40 communicates via a communications network 50 to the device 20. The post-processing graphing application 24 may then cause the processor 22 to store the layout 40 in the memory 26. The post-processing graphing application 24 may then accept the layout 40 as an input and post-process the layout 40. As later paragraphs will explain in more detail, exemplary embodiments may minimize a cost function 52 by imposing an ideal edge length 54 for pairs of vertices. Each vertex may be confined to a proximity location 56 about a current position 58 (as calculated by the spring-electrical algorithm 42 from the layout 40). Exemplary embodiments may also determine a penalty parameter 60 associated with each vertex for deviating too far from its current position 58.

Exemplary embodiments may then generate a proximity graph 70. The post-processing graphing application 24 may maintain each vertex's proximity location 56 by forming a graph edge from neighboring vertexes. The proximity graph 70 may then be merged or combined with the layout 40 to form a merged graph 72. The merged graph 72 may include edges from the layout 40 and edges from the proximity graph 70. The post-processing graphing application 24 may then minimize the cost function 52.

The device 20 and the application server 44 are only simply illustrated. Because the architecture and operating principles of processor-controlled devices are well known, their hardware and software components are not further shown and described. If the reader desires more details, the reader is invited to consult the following sources: ANDREW TANENBAUM, COMPUTER NETWORKS (4^{th} edition 2003); WILLIAM STALLINGS, COMPUTER ORGANIZATION AND ARCHITECTURE: DESIGNING FOR PERFORMANCE (7^{th} Ed., 2005); and DAVID A. PATTERSON & JOHN L. HENNESSY, COMPUTER ORGANIZATION AND DESIGN: THE HARDWARE/SOFTWARE INTERFACE (3^{rd}. Edition 2004).

Exemplary embodiments will now be explained in greater detail. The notation

G={V,E}

may denote an undirected graph, with V being the set of vertices and E being its edges. |V| and |E| denote the number of vertices and edges, respectively. If vertices i and j form an edge, that edge is denote as i⇄j, and i and j are called neighboring vertices. The notation xᵢ denotes the current coordinates of vertex i in two or three dimensional Euclidean space. Exemplary embodiments, then, find xᵢ for all iεV so that the resulting drawing provides a good visual representation of the connectivity information between vertices.

The layout 40 from the spring-electrical model xx usually is very good at revealing the global structure of a graph. The layout 40 may thus be locally fine-tuned to reduce warping effects. Exemplary embodiments may minimize the cost function 52 by imposing the ideal edge length 54. The cost function may be

Σ_{(i,j)εP}(∥x₁−xⱼ∥−dᵢⱼ)²

for pairs of vertices (i, j) in a set P, where is the set of all pairs {(i, j)|≠j, i, jεV}. Here dᵢⱼ is the ideal distance between vertices i and j. Because the spring electrical model is assumed to have produced a globally good layout, exemplary embodiments may refrain each vertex i from deviating too much from its current position, xᵢ^{o}. Exemplary embodiments may then add a penalty function to this cost function, resulting in the below “cost equation”

$${\sum }_{( i , j ) ∈ P} {{w}_{ij} ( ‖ {x}_{i} - {x}_{j} ‖ - {d}_{ij} )}^{2} + {\sum }_{i ∈ V} {λ}_{i} {‖ {x}_{i} - {x}_{i}^{0} ‖}^{2} .$$

Exemplary embodiments hereinafter denote this equation (or graph) as a localized stress model (or “LSM”). In this model, λᵢ is a penalty parameter that specifies the penalty imposed on vertex i for moving away from its current position. If λᵢ=0, and P is again the set of all pairs {(i,j)|i≠j, i, jεV}, then the penalty function is exactly the stress model. Exemplary embodiments, however, may localize the model by using a smaller set P. A smaller set P, such as P=E (where E is the set of edges for the undirected graph), may be more efficient. The smaller set P=E, however, may impose a distance requirement on neighboring vertices, so it may not resolve the problem of branches that cling to each other. On the other hand, a larger set P that includes most of the vertex pairs may result in an overly complex computation. Exemplary embodiments may thus balance quality with efficiency by setting the set P to be the vertex pairs with a graph theoretical distance of no more than two (2). If a graph has large 2-neighborhoods (such as a graph that contains a large star-like structure), the model still may still have a high complexity.

Exemplary embodiments may also determine the ideal distance dᵢⱼ for a pair of vertices. The ideal distance dᵢⱼ, for example, may be set as proportional to the graph theoretical distance (e.g., 1 or 2). Exemplary embodiments may alternatively set the ideal distance dᵢⱼ it to be related to the local average edge length. Repeated observations have shown that setting the ideal distance dᵢⱼ to be a power of the current distance

dᵢⱼ=∥xᵢ^{o}−xⱼ^{o}∥^{t}, t<1

works well. Exemplary embodiments may scale the above ideal distance to the proper unit, as later paragraphs will explain.

Repeated observations also suggest that the localized stress model adequately visualizes mesh-like graphs. On the other hand, for sparse networks with many degree-1 nodes, the localized stress model may be too conservative in expanding the layout to fill up the available white space, due to the penalty term. If the penalty is reduced by using smaller penalty parameters λᵢ, the final layout may deviate from the initial layout 40 so significantly that many of the nice features of the initial layout 40 are lost. The reason may be that the penalty term

λᵢ∥xᵢ−xᵢ^{o}∥²

imposes a stringent constraint on the position of the vertex with reference to its current position. A more flexible, yet, adequate constraint may be to maintain the relative vertex positions. Exemplary embodiments may thus establish a scaffolding structure. This scaffolding structure may allow each vertex to move around (e.g., a vertex's proximity location 56), yet exemplary embodiments may maintain each vertex's relative position.

Scaffolding is constructed using the proximity graph 70. The proximity graph 70 may be derived from a set of points in the space. Points that are neighbors tend to form an edge in the proximity graph 70. There are several methods of creating the proximity graph 70, and exemplary embodiment may use any of these known methods. Examples will be provided below using the following two methods:
1) The Delaunay triangulation (or “DT”), where two points are neighbors if and only if there exists a sphere passing through the two points, and no other points lie in the interior of this sphere; and
2) The relative neighborhood graph (or “RNG”), where two points xᵢ and xⱼ are neighbors in if and only if no point xₖ is both closer to xᵢ than xⱼ and closer to xⱼ than xᵢ. The relative neighborhood graph may thus be a spanning subgraph of the Delaunay triangulation.
   Exemplary embodiments may first form the proximity graph 70 (such as using the Delaunay triangulation and/or the relative neighborhood graph). The data from the proximity graphs 70 may then be merged with the layout 40 (from the spring electrical model 42). This merged data thus forms the new merged graph (illustrated as reference numeral 72 in FIG. 2)

G′={V,E′},

whose edges may include both the original edges (from the layout 40) and the edges from the proximity graph 70. Exemplary embodiments may minimize a cost function

$${\sum }_{( i , j ) ∈ {E}^{′}} {{w}_{ij} ( ‖ {x}_{i} - {x}_{j} ‖ - {d}_{ij} )}^{2} ,$$

with dᵢⱼ being the ideal distance between vertices i and j (as above explained).

The Delaunay triangulation may be a planar graph. The Delaunay triangulation may therefore have no more than (3|V|−3) edges. Hence G′ may have the same number of vertices, and no more than (3|V|−3) extra edges, compared with the original graph. Furthermore, G′, as a spanning supergraph of the Delaunay triangulation, is rigid, therefore providing a good scaffolding that constrains the relative positions of the vertices and helps to preserve the good global structure of the spring-electrical layout 40. The proximity graph 70 may thus be denoted as a proximity graph-based model (or “PGM”).

The localized stress model and the proximity graph-based model will now be graphically evaluated. The baseline algorithm is a multilevel spring-electrical algorithm, hereafter denoted as Scalable Force Directed Placement (or “SFDP”). The Scalable Force Directed Placement checks the input graph, and may automatically switch to an alternative repulsive force model, which is known to those of ordinary skill in the art as:

$${F}_{r} ( i , j ) = \frac{{K}^{1 - p}}{{‖ {x}_{i} - {x}_{j} ‖}^{1 + p}} ( {x}_{i} - {x}_{j} ) , i \neq j .$$

When at least thirty percent (30%) of the nodes are of degree 1, then p=1.8. Exemplary embodiments used the mesh generator “Triangle” for triangulation (see Jonathan Richard Shewchuk, Triangle: Engineering a 2D Quality Mesh Generator and Delaunay Triangulator, in APPLIED COMPUTATIONAL GEOMETRY: TOWARDS GEOMETRIC ENGINEERING’ (Ming C. Lin and Dinesh Manocha, editors), volume 1148 of Lecture Notes in Computer Science, pages 203-222, Springer-Verlag, Berlin, May 1996). All the results were generated on a 64-bit LINUX® machine with an INTEL® XEON® 3.20 GHz processor and 8 GB of memory, using the GCC (GNU Compiler Collection) compiler, version 3.4.6.

Because both the localized stress model and the proximity graph-based model are very close in form to the stress model, each may be solved by applying the known stress majorization technique, which has been demonstrated to be a robust algorithm for finding the minimum of

$${\sum }_{i \neq j} {{w}_{ij} ( ‖ {x}_{i} - {x}_{j} ‖ - {d}_{ij} )}^{2} ,$$

where dᵢⱼ is the graph theoretical distance between vertices I and j, and where ωᵢⱼ is a weight factor (which is typically 1/dᵢⱼ²). Consider the cost function of the localized stress model:

$$f ( x ) = {\sum }_{( i , j ) ∈ P} {{w}_{ij} ( ‖ {x}_{i} - {x}_{j} ‖ - {d}_{ij} )}^{2} + {\sum }_{i ∈ V} {λ}_{i} {‖ {x}_{i} - {x}_{i}^{o} ‖}^{2} \\ = {\sum }_{( i , j ) ∈ P} ( {w}_{ij} {‖ {x}_{i} - {x}_{j} ‖}^{2} - 2 {d}_{ij} {w}_{ij} ‖ {x}_{i} - {x}_{j} ‖ + {w}_{ij} {d}_{ij}^{2} ) + \\ {\sum }_{i ∈ V} {λ}_{i} {‖ {x}_{i} - {x}_{i}^{o} ‖}^{2}$$

All the terms above are either constant, linear, or quadratic with regard to x, except the second term. Using the known Cauchy-Schwartz inequality,

(xᵢ−xⱼ)^{T}(yᵢ−yⱼ)≦∥xᵢ−xⱼ∥∥yᵢ−yⱼ∥,

the cost function may be bound by

$$g ( x , y ) = {\sum }_{( i , j ) ∈ P} ( \begin{matrix}{w}_{ij} {‖ {x}_{i} - {x}_{j} ‖}^{2} - \\ 2 {d}_{ij} {w}_{ij} \frac{{( {x}_{i} - {x}_{j} )}^{T} ( {y}_{i} - {y}_{j} )}{‖ {y}_{i} - {y}_{j} ‖} + {w}_{ij} {d}_{ij}^{2}\end{matrix} ) + {\sum }_{i ∈ V} {λ}_{i} {‖ {x}_{i} - {x}_{i}^{o} ‖}^{2} ,$$

with the bound tight when y=x. The idea of stress majorization is to minimize a sequence of the quadratic function g(x,y^{k}), with y⁰=x⁰ as the initial layout, and the subsequent y^{k} as the result of minimizing g(x,y^{k-1}), where k=1, 2, . . . .

The minimum of the quadratic function g(x,y) is derived by setting

∂ₓ_{ᵢ}g(x,y)=0,

thus giving

(L_{ω}+Λ)x=L_{ω,d}y+Λx^{C}

(Equation 1), where the weighted Laplacian matrix L_{ω has elements}

$${( {L}_{w} )}_{ij} = \{ \begin{matrix}{\sum }_{( i , l ) ∈ P} {w}_{i 1} , & i = j \\ - {w}_{i , j} , & i \neq j\end{matrix}$$

and matrix L_{ω,d} has elements

$${( {L}_{w , d} )}_{ij} = \{ \begin{matrix}{\sum }_{( i , j ) ∈ P} {w}_{i 1} {d}_{i 1} / ‖ {y}_{i} - {y}_{j} ‖ , & i = j \\ - {w}_{ij} {d}_{ij} / ‖ {y}_{i} - {y}_{j} ‖ , & i \neq j\end{matrix}$$

In equation 1 above, Λ is a diagonal matrix, with the i^{th} diagonal entry λᵢ. Therefore, the problem of finding a minima of g(x,y) becomes that of solving the linear system of equation 1, with the left hand side matrix fixed and sparse (provided that P is a small subset of all possible vertex pairs). In fact, when all penalty parameters λᵢ are positive, then the matrix

L_{ω}+Λ

is diagonally dominant, so an iterative procedure such as the known preconditioned conjugate gradient method may converge quickly on the linear system. Here a diagonal preconditioner is used to terminate the conjugate gradient algorithm if the relative 2-norm residual for equation 1 is less than (0.01). A tighter tolerance is not necessary because the solution of equation 1 constitutes an intermediate step of the stress majorization. The resulting solution x^{k} is used to substitute for the term y in equation 1, and the linear system may again be solved until

∥x^{k+1}−x^{k}∥/|V|<ε.

These examples used ε=0.001. The proximity graph model may be similarly solved using the stress majorization procedure, except here P=E′, and terms related to the penalty parameters vanish.

For the localized stress model, the ideal distance may need to be suitably scaled. The scaling factor s is chosen to minimize the initial stress f(x⁰),

$${( {\sum }_{( i , j ) ∈ P} {{w}_{ij} ( \vert {x}_{i}^{0} - {x}_{j}^{0} ‖ - {sd}_{ij} )}^{2} + \sum {λ}_{i} {‖ {x}_{i}^{0} - {x}_{i}^{0} ‖}^{2} )}_{ϑ}^{i} = 0$$

$$or$$

$$s = \frac{{\sum }_{( i , j ) ∈ P} {w}_{ij} ‖ {x}_{i}^{0} - {x}_{j}^{0} ‖ {d}_{ij}}{{\sum }_{( i , j ) ∈ P} {w}_{ij} {d}_{ij}^{2}}$$

Different values of t in the ideal distance formula

dᵢⱼ=∥xᵢ⁰−xⱼ⁰∥^{t}

reveals that t=0.4 works well for the localized stress model.

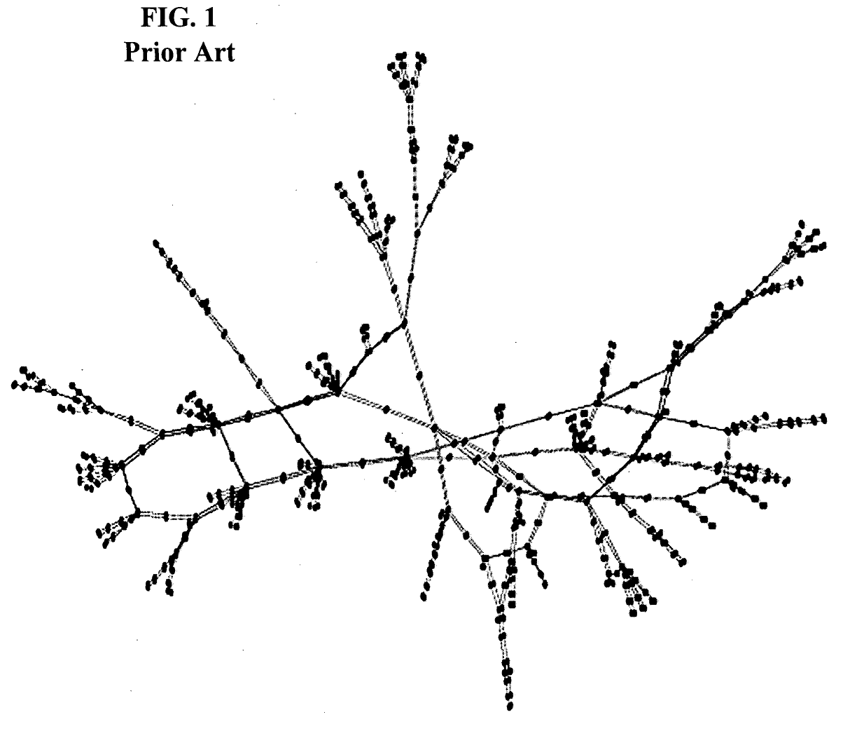

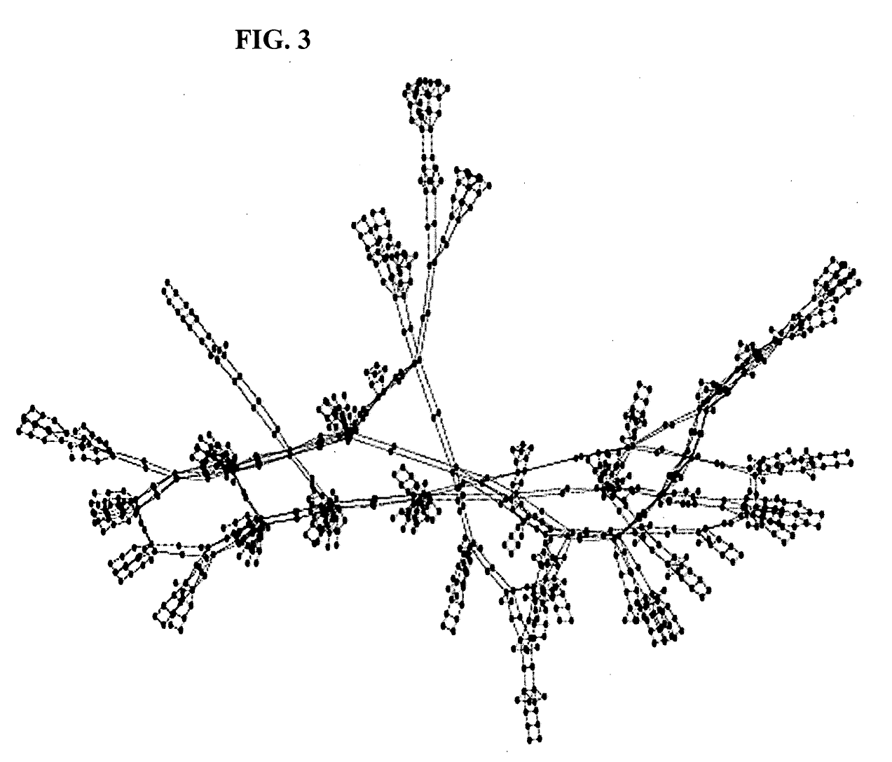

FIG. 3 is a schematic illustrating a result of the localized stress model, according to exemplary embodiments. When the penalty parameters λᵢ are set equal to (0.05), FIG. 3 illustrates the result of the localized stress model on graph qh882. FIG. 3 illustrates that the localized stress model improves upon the original drawing (of FIG. 1) by revealing more details of the graph, such as a ladder structure. At the same time, FIG. 3 illustrates that the localized stress model does not deviate very much from the original drawing (of FIG. 1).

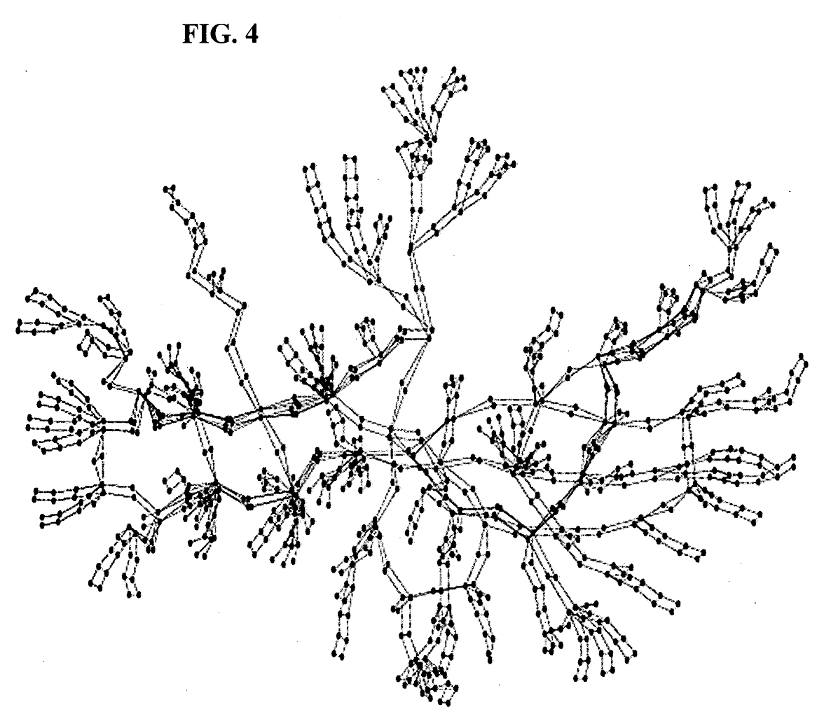

FIG. 4 is a schematic illustrating a result of the proximity graph-based model, according to exemplary embodiments. Here the Delaunay triangulation was used as the proximity graph 70, and the distance formula

dᵢⱼ=∥xᵢ⁰−xⱼ⁰|^{0.6}

was used (with 0.6 as the default setting for the proximity graph-based model). When FIGS. 3 and 4 are compared, the result of the proximity graph-based model utilizes more available space. For example, the branch at a top region is now expanded and can be seen more clearly in FIG. 4. The proximity graph-based model, though, twists some branches which were straight in the original drawing (e.g., FIG. 1), such as the branch at the bottom of FIG. 1. The reason is that Delaunay triangulation can create edges that link far away vertices together.

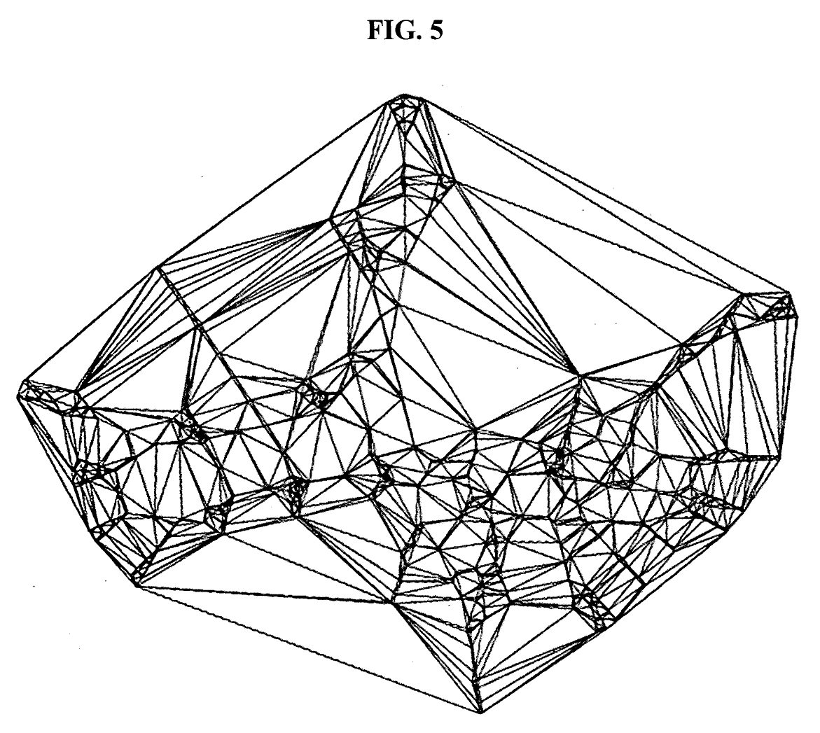

FIG. 5 is a schematic illustrating the proximity graph 70 that applies the Delaunay triangulation to the vertices of FIG. 1, according to exemplary embodiments. In this Delaunay triangulation there is a particularly long edge linking the bottom most vertex with one to the left. In addition there are four long edges that link the bottom branch to a vertex to the right. Because the ideal distance of the proximity graph-based model was set to be the 0.6 power of the current distance, the bottom branch is pulled to the left and right, which explains the kink of this branch seen in FIG. 4.

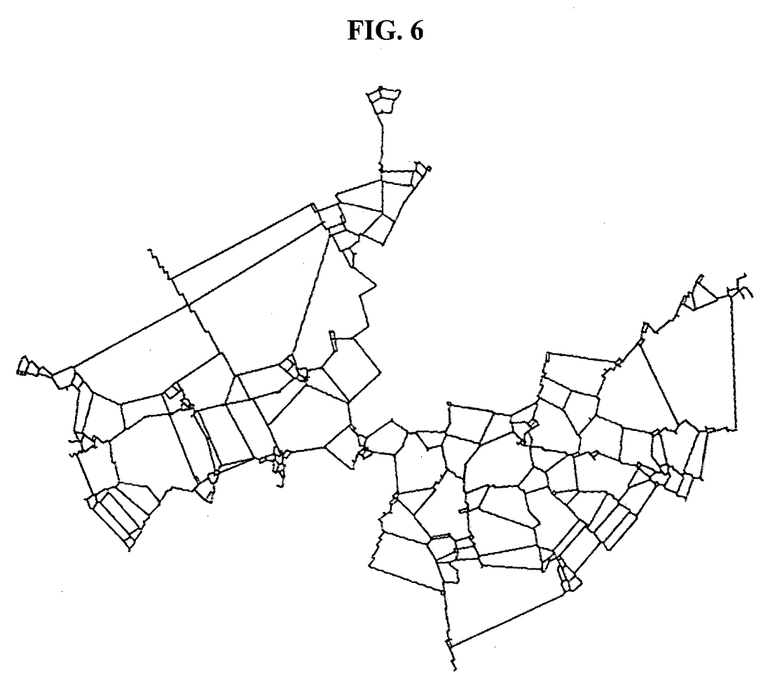

FIG. 6 is a schematic illustrating a relative neighborhood graph of the vertices of FIG. 1, according to exemplary embodiments. Experiments were conducted with a relative neighborhood graph based on the proximity graph-based model. Here, for computational convenience and efficiency, following the inventor's previously published work, an approximation may be generated to the relative neighborhood graph by starting from a Delaunay triangulation, and removing Delaunay edges between vertices i and j if there is a vertex k adjacent to i or j, such that

∥xᵢ−xⱼ∥>min{∥xᵢ−xₖ∥,∥xⱼ−xₖ∥}.

Because only neighboring vertices were checked, the result is a superset of the true relative neighborhood graph. FIG. 6 illustrates this relative neighborhood graph for the original layout (of FIG. 1).

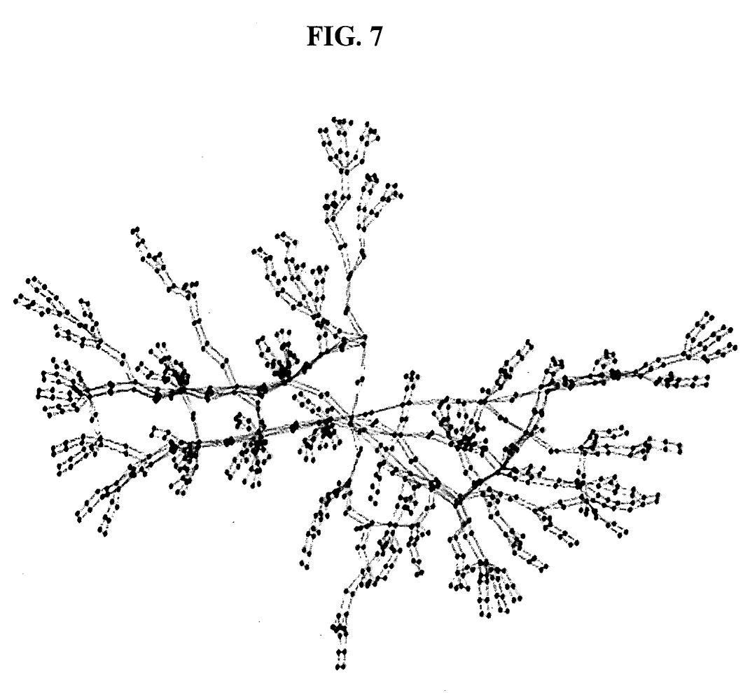

FIG. 7 is a schematic illustrating a result of the proximity graph-based model using relative neighborhood graph, according to exemplary embodiments. While Delaunay triangulation may be rigid, FIG. 6 illustrates that the relative neighborhood graph is not. If the reader imagines that edges are rods and that vertices are joints, the top branch of FIG. 6 is clearly flexible and can swing to the left or right. The consequence of this non-rigidity is that realizable layout that minimizes the cost function (illustrated as reference numeral 52 in FIG. 2 and described by the cost equation of paragraph [0021]) is not unique, and is subject to deformation. For some non-rigid graphs, parts of the layout after applying relative neighborhood graph based proximity graph-based model can fold into each other. For graph qh882, however, this proved not to be a real issue and the resulting layout of FIG. 7 is reasonable.

The Delaunay triangulation based proximity graph-based model was applied to graph dwt_{—}1005 with |V|=1005 and |E|=3808. Because of the many long edges that exist in Delaunay triangulation, for mesh like graphs, Delaunay triangulation based proximity graph-based model may not be suitable as it tends to destroy the symmetry that exists in the drawing of the spring-electrical model. The relative neighborhood based proximity graph-based model, though, tends to suffer less from this problem.

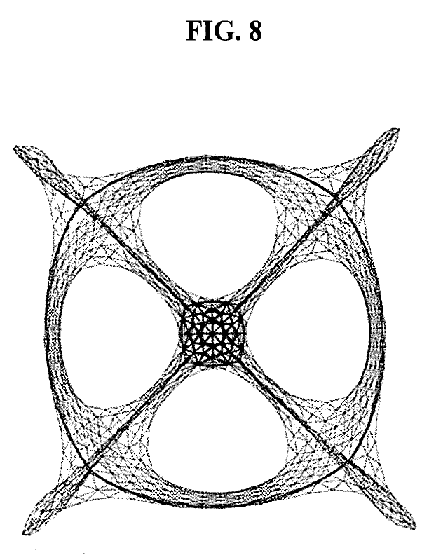

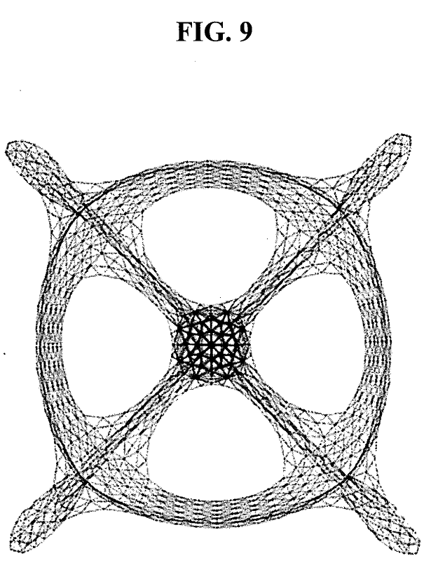

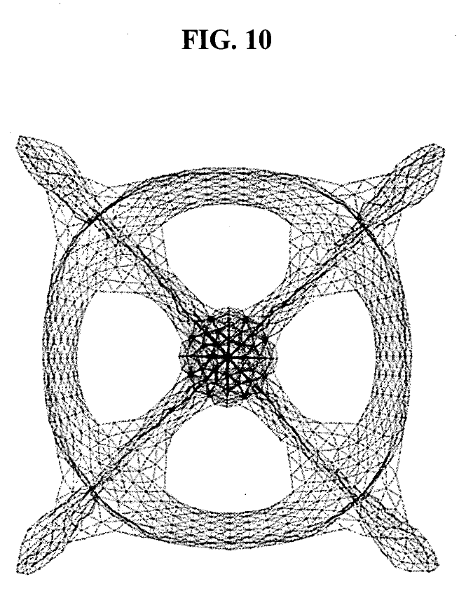

FIGS. 8-10 are schematics illustrating the post-processing transformation, according to exemplary embodiments. Here the post-processing algorithms described above are applied to graph dwt_{—}1005 with |V|=1005 and |E|=3808. FIG. 8 illustrates the post-processing algorithms applied to the Scalable Force Directed Placement. FIG. 9 illustrates the layout after applying the localized stress model. FIG. 10 illustrates the layout after applying the relative neighborhood based proximity graph-based model. For sparser graphs, however, the long edges in the Delaunay triangulation proved very effective in pulling out branches that cling to each other, thus utilize the empty space.

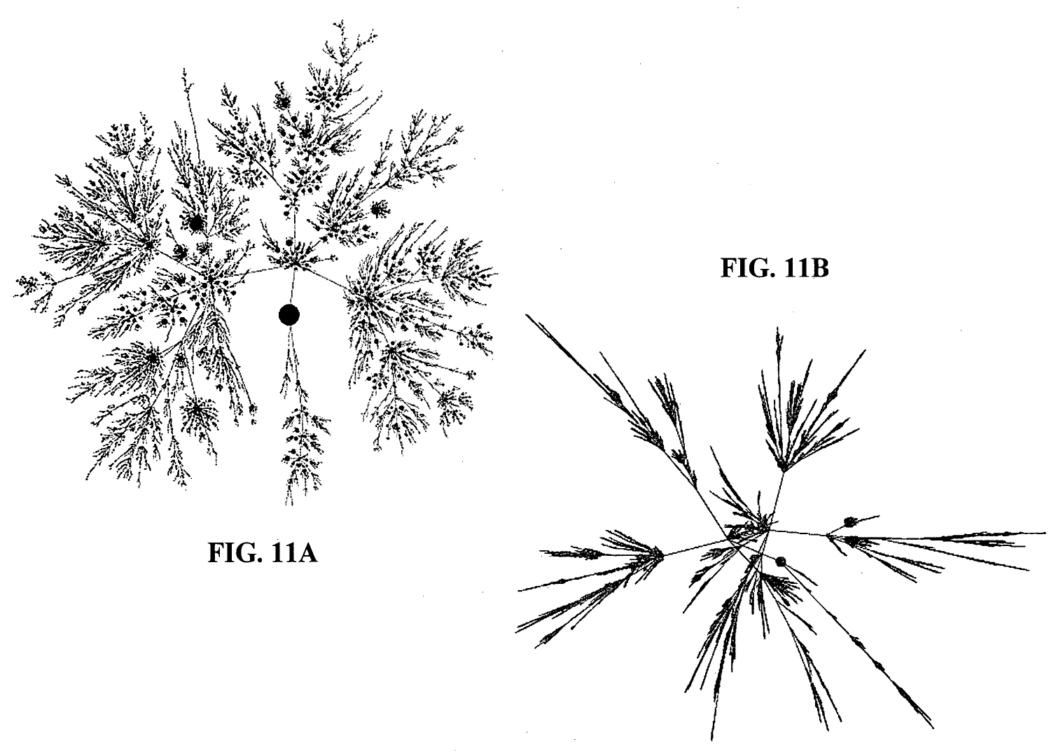

FIG. 11 is another schematic illustrating a warping effect suffered by force directed algorithms, before the post processing algorithm 24 is applied. FIG. 11A illustrates a result of applying the post-processing transformation to the baseline spring-electrical algorithm Scalable Force Directed Placement on the known USA.ncol graph with |V|=44954 and |E|=44953. This graph is a spanning tree taken from a web crawl graph. The drawing is pleasing and highlights the tree nature of this graph. However, there are a lot of white spaces that are not utilized. This is a common problem for the spring-electrical model, and is also seen in other implementations. FIG. 11B illustrates the result of applying the known FM³ algorithm with the default settings. Here the warping effects, with the branches tightly clinging together, is also obvious.

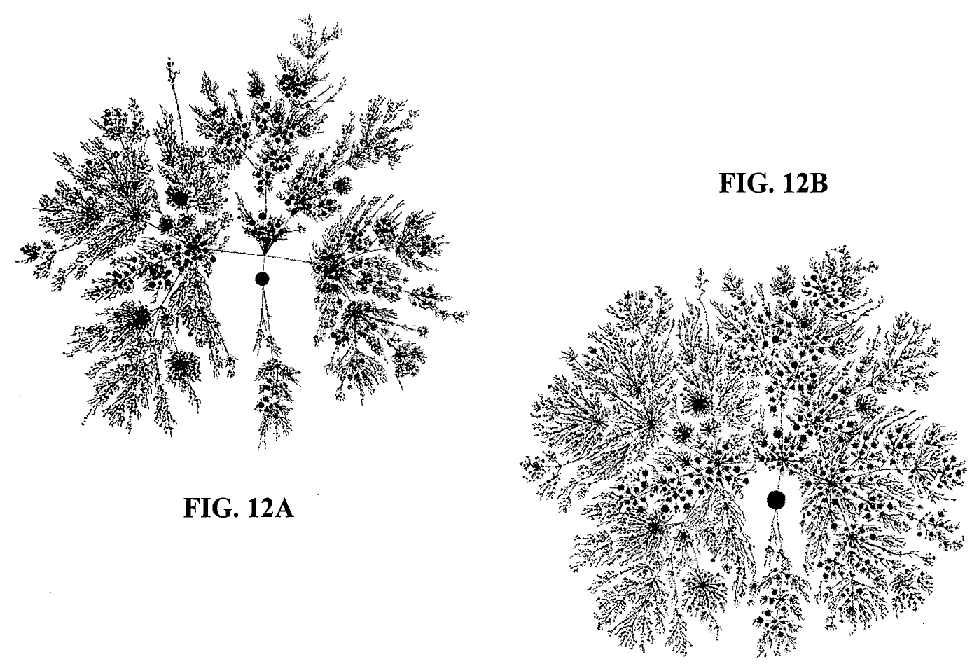

FIG. 12 is a schematic illustrating post-processing transformations, according to exemplary embodiments. FIG. 12A illustrates layouts when the localized stress model are applied to the layout illustrated in FIG. 11A. One of ordinary skill in the art recognizes that the localized stress model improves space utilization. For such sparse graphs, it may be beneficial to augment the original edge set with the Delaunay edges, thus making the graph rigid and enabling the stress function to preserve relative position well. FIG. 12B illustrates this augmentation, which is based on the proximity graph-based model, and may be superior to FIG. 12A.

In terms of computational cost, both the localized stress model and the proximity graph-based model are relatively cheap. Table 1 (below) illustrates various CPU processing times (in seconds) for laying out a graph, along with the post processing time, according to exemplary embodiments. For graphs that do not contain any large 2-neighborhood (e.g., dwt_{—}1005 and qh882), the localized stress model is faster because the penalty term makes the linear system involved in stress majorization more strongly diagonally dominant, hence conjugate gradient algorithm converges in less iterations, and computational cost per iteration is also small. However for the USA.ncol graph, the localized stress model is slower. This is because the graph contains a large star structure (seen as the dense round clump near the center of FIG. 10A). This makes the 2-neighborhood graph within this structure a complete graph, hence even though conjugate gradient algorithm still converges in small number of iterations (stress majorization took five (5) iterations, and the average number of iterations for conjugate gradient is seven (7)), the relatively dense matrix makes the computational cost higher compared with proximity graph-based model, whose matrix is almost as sparse as the adjacency matrix of the original graph. For the proximity graph-based model, stress majorization takes nineteen (19) iterations, and on average the conjugate gradient takes 132 iterations to converge. As a benchmark, in the table is also included the CPU time for the known FM³ algorithm.

TABLE 1
Comparing the CPU time (in seconds) for the baseline algorithm SFDP,
post processing algorithms LSM and Delaunay triangulation based PGM,
as well as the known FM³ algorithm.

| Graph | \|V\| | \|E\| | SFDP | LSM | PGM | FM³ |
|---|---|---|---|---|---|---|
| USA.ncol | 44954 | 44953 | 174 | 57 | 31 | 130 |
| dwt_1005 | 1005 | 7616 | 1. | 0.05 | 0.6 | 1.68 |
| qh882 | 882 | 3066 | 0.93 | 0.03 | 0.44 | 1.79 |

Exemplary embodiments may thus utilize one or more post-processing algorithms to overcome the warping effects of the spring-electrical model. The algorithms explained above are efficiently implemented and produce aesthetic, accurate drawings for very large graphs.

Exemplary embodiments may be incorporated into any graphing program. There are many graphing applications (such as TOM SAWYER®, YFILES®, and ILOG®), and exemplary embodiments may be integrated or incorporated into any graphing applications. Because graphing applications are well known, no further explanation is needed.

Exemplary embodiments may be applied regardless of networking environment. The communications network 50 (illustrated in FIG. 2) may be a cable network operating in the radio-frequency domain and/or the Internet Protocol (IP) domain. The communications network 50, however, may also include a distributed computing network, such as the Internet (sometimes alternatively known as the “World Wide Web”), an intranet, a local-area network (LAN), and/or a wide-area network (WAN). The communications network 50 may include coaxial cables, copper wires, fiber optic lines, and/or hybrid-coaxial lines. The communications network 50 may even include wireless portions utilizing any portion of the electromagnetic spectrum and any signaling standard (such as the I.E.E.E. 802 family of standards, GSM/CDMA/TDMA or any cellular standard, and/or the ISM band). The communications network 50 may even include powerline portions, in which signals are communicated via electrical wiring. The concepts described herein may be applied to any wireless/wireline communications network, regardless of physical componentry, physical configuration, or communications standard(s).

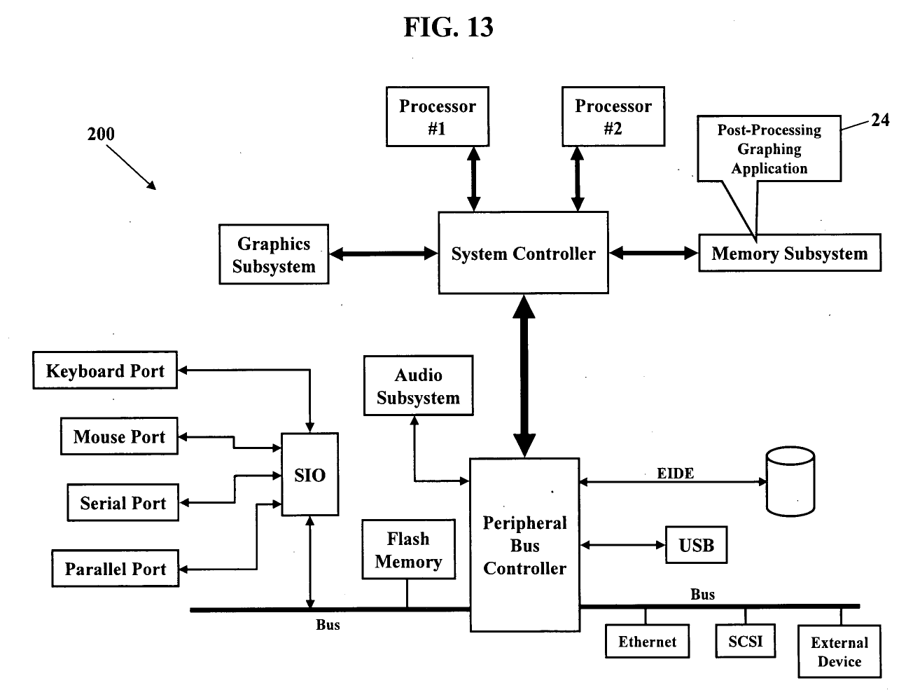

FIG. 13 is a schematic illustrating still more exemplary embodiments. FIG. 13 is a generic block diagram illustrating the post-processing graphing application 24 may operate within a processor-controlled device 200. The post-processing graphing application 24 may be stored in a memory subsystem of the processor-controlled device 200. One or more processors communicate with the memory subsystem and execute the post-processing graphing application 24. Because the processor-controlled device 200 illustrated in FIG. 13 is well-known to those of ordinary skill in the art, no detailed explanation is needed.

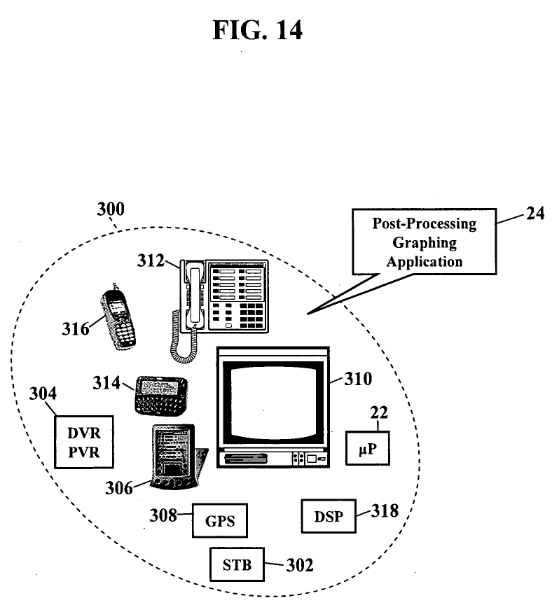

FIG. 14 depicts other possible operating environments for additional aspects of the exemplary embodiments. FIG. 14 illustrates that the exemplary embodiments may alternatively or additionally operate within various other devices 300. FIG. 14, for example, illustrates that the post-processing graphing application 24 may entirely or partially operate within a set-top box (“STB”) (302), a personal/digital video recorder (PVR/DVR) 304, personal digital assistant (PDA) 306, a Global Positioning System (GPS) device 308, an interactive television 310, an Internet Protocol (IP) phone 312, a pager 314, a cellular/satellite phone 316, or any computer system, communications device, or processor-controlled device utilizing the processor 22 and/or a digital signal processor (DP/DSP) 318. The device 300 may also include watches, radios, vehicle electronics, clocks, printers, gateways, mobile/implantable medical devices, and other apparatuses and systems. Because the architecture and operating principles of the various devices 300 are well known, the hardware and software componentry of the various devices 300 are not further shown and described. If, however, the reader desires more details, the reader is invited to consult the following sources: LAWRENCE HARTE et al., GSM SUPERPHONES (1999); SIEGMUND REDL et al., GSM AND PERSONAL COMMUNICATIONS HANDBOOK (1998); and JOACHIM TISAL, GSM CELLULAR RADIO TELEPHONY (1997); the GSM Standard 2.17, formally known Subscriber Identity Modules, Functional Characteristics (GSM 02.17 V3.2.0 (1995-01))”; the GSM Standard 11.11, formally known as Specification of the Subscriber Identity Module—Mobile Equipment (Subscriber Identity Module—ME) interface (GSM11.11 V5.3.0 (1996-07))”; MICHEAL ROBIN & MICHEL POULIN, DIGITAL TELEVISION FUNDAMENTALS (2000); JERRY WHITAKER AND BLAIR BENSON, VIDEO AND TELEVISION ENGINEERING (2003); JERRY WHITAKER, DTV HANDBOOK (2001); JERRY WHITAKER, DTV: THE REVOLUTION IN ELECTRONIC IMAGING (1998); and EDWARD M. SCHWALB, ITV HANDBOOK: TECHNOLOGIES AND STANDARDS (2004).

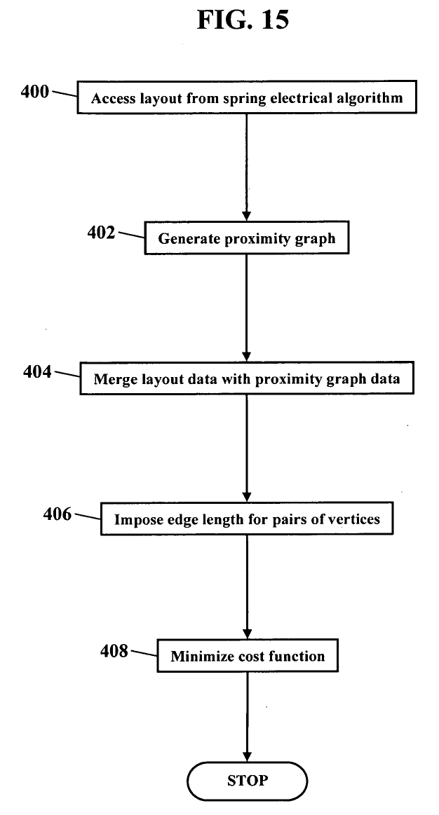

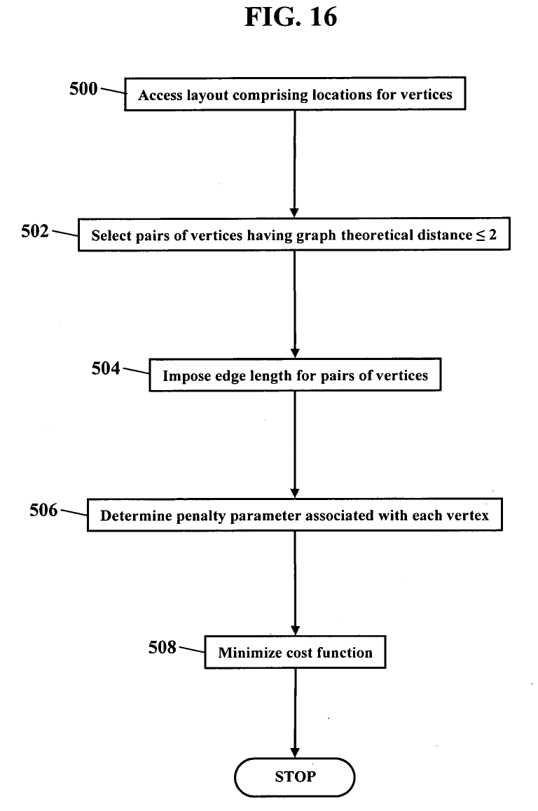

FIG. 15 is a flowchart illustrating a method of graphing data, according to exemplary embodiments. The layout 40 from the spring electrical algorithm 42 is accessed (Block 400). The proximity graph 70 is generated (Block 402). The layout 40 and the proximity graph 70 are merged to form the merged graph 72 (Block 404). An edge length is imposed for pairs of vertices (Block 406). A cost function is minimized (Block 408).

FIG. 16 is another flowchart illustrating another method of graphing data, according to exemplary embodiments. The layout 40 is accessed that comprises locations for vertices (Block 500). Pairs of vertices are selected having a graph theoretical distance less than or equal to two (2) (Block 502). An edge length for a pair of vertices may be imposed (Block 504). The penalty parameter 60 associated with each vertex is determined (Block 506). A cost function 52 associated with the layout 40 is minimized (Block 508).

Exemplary embodiments may be physically embodied on or in a computer-readable storage medium. This computer-readable medium may include CD-ROM, DVD, tape, cassette, floppy disk, memory card, and large-capacity disks. This computer-readable medium, or media, could be distributed to end-subscribers, licensees, and assignees. These types of computer-readable media, and other types not mention here but considered within the scope of the exemplary embodiments. A computer program product comprises processor-executable instructions for graphing data.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method of graphing data, comprising:
executing a software application stored in memory that is executed by a processor;
retrieving a layout from the memory that comprises locations for vertices;
generating a proximity location by the processor for each vertex;
merging each vertex's location from the layout with each vertex's proximity location; and
minimizing a cost function associated with the layout.

2. The method according to claim 1, further comprising confining a vertex to its corresponding proximal location about its respective location from the layout.

3. The method according to claim 1, wherein retrieving the layout comprises retrieving the layout produced by a spring electrical algorithm.

4. The method according to claim 1, further comprising determining a penalty parameter associated with each vertex.

5. The method according to claim 1, further comprising imposing a penalty on a vertex for deviating from its corresponding location.

6. The method according to claim 1, further comprising imposing an edge length for a pair of vertices.

7. The method according to claim 1, further comprising maintaining each vertex's proximity location.

8. The method according to claim 1, further comprising forming a graph edge from neighboring vertexes.

9. The method according to claim 1, further comprising generating a proximity graph.

10. The method according to claim 9, further comprising merging an edge from the layout with another edge from the proximity graph.

11. The method according to claim 1, further comprising selecting pairs of vertices with a graph theoretical distance less than or equal to two (2).

12. A system for graphing data, comprising:
a processor executing a software application stored in memory, the software application causing the processor to:
retrieve a layout from the memory that comprises locations for vertices;
generate a proximity location for each vertex;
merge each vertex's location from the layout with each vertex's proximity location; and
minimize a cost function associated with the layout.

13. The system according to claim 12, the software application further causing the processor to confine a vertex to its corresponding proximal location about its respective location from the layout.

14. The system according to claim 12, the software application further causing the processor to retrieve the layout produced by a spring electrical algorithm.

15. The system according to claim 12, the software application further causing the processor to determine a penalty parameter associated with each vertex.

16. The system according to claim 12, the software application further causing the processor to impose a penalty on a vertex for deviating from its corresponding location.

17. The system according to claim 12, the software application further causing the processor to impose an edge length for a pair of vertices.

18. The system according to claim 12, the software application further causing the processor to generate a proximity graph.

19. A computer readable medium storing processor executable instructions for performing a method, the method comprising:
retrieving a layout from the memory that comprises locations for vertices;
generating a proximity location by the processor for each vertex;
merging each vertex's location from the layout with each vertex's proximity location; and
minimizing a cost function associated with the layout.

20. The computer readable medium according to claim 19, further comprising instructions for imposing a penalty on a vertex for deviating from its corresponding location.
